(19) United States
(12) Patent Application Publication
(10) Pub. No.: US 2015/0319468 A1
(43) Pub. Date: Nov. 5, 2015

(54) SYSTEM, APPARATUS, AND METHOD FOR RECOMMENDING TV PROGRAM BASED ON CONTENT

(71) Applicant: SNU R&DB FOUNDATION, Seoul (KR)

(72) Inventors: Tae-Suh PARK, Seoul (KR); Byoung-Hee KIM, Seoul (KR); Byoung-Tak ZHANG, Seoul (KR)

(73) Assignee: SNU R&DB FOUNDATION, Seoul (KR)

(21) Appl. No.: 14/602,431

(22) Filed: Jan. 22, 2015

(30) Foreign Application Priority Data
Apr. 30, 2014 (KR) 10-2014-0052807

(51) Int. Cl. H04N 21/25; H04N 21/234

(52) U.S. Cl. CPC H04N 21/251; H04N 21/23418

(57) ABSTRACT

There is provided a system for recommending a TV program based on content, the system including: a terminal device configured to: decode and output a received broadcast stream; extract affectors by analyzing a video that is being played by the video player; estimate affects that are an implicit response of a viewer of the video; and learn a preference model using an affect matching each of the affectors and transmit the learned preference model to a recommendation server, and a recommendation server configured to: in response to receipt of a preference model, estimate real-time preference by applying the preference model to each of the plurality of channels in real time; and register a specific TV program in a recommendation list and transmit the recommendation list to the terminal device in a case where a real-time preference for the specific TV program is equal to or greater than a predetermined level.

### CROSS-REFERENCE TO RELATED APPLICATION(S)

This application claims priority from Korean Patent Application No. 10-2014-0052807, filed on Apr. 30, 2014, in the Korean Intellectual Property Office, the entire disclosure of which is incorporated herein by reference for all purposes.

### BACKGROUND

1. Field

The following description relates to a system, apparatus, and method for solving the key issues of a function of recommending a broadcasting channel/program in a smart TV or an Internet Protocol Television (IPTV) set-top box.

2. Description of the Related Art

Recently, smart TVs and Internet Protocol Televisions (IPTVs) are widely used. An IPTV refers to a service for providing information service, video content, broadcast stream, and the like, to a television receiver using high-speed Internet. In addition, a smart TV refers to a television receiver that is capable of accessing high-speed Internet and has an IPTV function. Both of the IPTV and the smart TV are a combination of the Internet and a television, which may be regarded as a kind of digital convergence.

Due to the widespread use of the IPTV, smart TV, and channel diversification, viewers are allowed to select a program of their choice from among hundreds of channels.

The wide range of channels, however, is not always good for viewers for several reasons. In the past, there were few terrestrial broadcast channels, and viewers selected a desired program by clicking external buttons ten times (that is, pressing a Channel Up/Down button to change channels in consecutive order). On the other hand, as the number of channels has increased to hundreds, viewers need to spend more time zapping through channels. Even for content providers, it is hard to cope with the current situation. Competition is getting fierce as more and more programs are provided through hundreds of channels to a limited number of viewers. Thus, it is such a challenge for content providers to expose their programs to viewers who would prefer watching the programs. In particular, many viewers feel bothered to select one of hundreds of channels every time, so they register some channels they found interesting in the past, and visit only the registered channels. Consequently, content providers need to come up with an idea to lessen the burden of selecting channels for viewers. By doing so, content providers may maintain business and meet viewer satisfaction. To solve the drawback of zapping through hundreds of channels, an Electronic Program Guide (EPG) function has been introduced. However, it is not a perfect solution since there are many options, and it is inconvenient to manipulate. Thus, the situation is clear that recommendations to help viewers select channels is essential.

A conventional video content recommending method is based on a collaborative filtering technique. The collaborative filtering technique is a method of recommending content items that are preferred by other users with the same taste based on ratings from a plurality of users. The collaborative filtering technique is widely used to recommend movies or books, which are rated by many people. However, as many TV programs are live or new due to the media characteristics of TV, there may not be any view history or ratings, and thus, it is impossible to apply the collaborative filtering technique.

### SUMMARY

The following description relates to a system, apparatus, and method for recommending an optimized program from among programs having no rating information, by acquiring low-rate information on programs having no prior rating information and viewer's emotional responses to the low-rate information in real time during television viewing, and then by raining and applying a preference model.

In one general aspect, there is provided a system for recommending a TV program based on content, comprising: a terminal device which is configured to: decode and output a received broadcast stream, extract affectors by analyzing a video that is being played by the video player, estimate affects that are an implicit response of a viewer of the video that is being played by the video player, and learn a preference model using an affect matching each of the affectors and transmit the learned preference model to a recommendation server; and the recommendation server configured to: in response to receipt of a preference model from a terminal device, estimate real-time preference for each of a plurality of channels by applying the preference model to each of the plurality of channels in real time; and register a specific TV program in a recommendation list and transmit the recommendation list to the terminal device in a case where a real-time preference for the specific TV program is equal to or greater than a predetermined level.

In another general aspect, there is provided a terminal device comprising: a video player configured to decode and output a received broadcast stream; a video analyzer configured to extract affectors by analyzing a video that is being played by the video player; a viewer analyzer configured to estimate affects that are an implicit response of a viewer of the video that is being played by the video player; and a preference learner configured to learn a preference model using an affect matching each of the affectors, and transmit the learned preference model to a recommendation server.

In yet another general aspect, there is provided a recommendation server comprising: a real-time preference estimator configured to, in response to receipt of a preference model from a terminal device, estimate real-time preference for each of a plurality of channels by applying the preference model to each of the plurality of channels in real time; and a recommendation manager configured to register a specific TV program in a recommendation list and transmit the recommendation list to the terminal device in a case where a real-time preference for the specific TV program is equal to or greater than a predetermined level.

In yet another general aspect, there is provided a method for recommending a TV program based on content, comprising: decoding and outputting a received broadcast stream; extracting affectors by analyzing an output video; estimating affects that are a response of a viewer of the video; learning a preference model using an affect matching each of the affectors; and transmitting the learned preference model to a recommendation server.

Other features and aspects may be apparent from the following detailed description, the drawings, and the claims.

### BRIEF DESCRIPTION OF THE DRAWINGS

FIG. 1 is a diagram illustrating a terminal device according to an exemplary embodiment.

FIG. 2 is a diagram illustrating a recommendation server according to an exemplary embodiment.

FIG. 3 is a flowchart for explanation of a process of generating a preference model according to a viewer's response according to an exemplary embodiment.

FIG. 4 is a flowchart for explanation of a process of generating a recommendation list using a preference model according to an exemplary embodiment.

FIG. 5 is a flowchart for explanation of a process of outputting a recommendation list for a viewer according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A preferred embodiment of the present invention will be described herein below with reference to the accompanying drawings. In the following description, well-known functions or constructions are not described in detail since they would obscure the invention in unnecessary detail. The terms used herein are defined in consideration of the functions of elements in the present invention. The terms can be changed according to the intentions or the customs of a user and an operator.

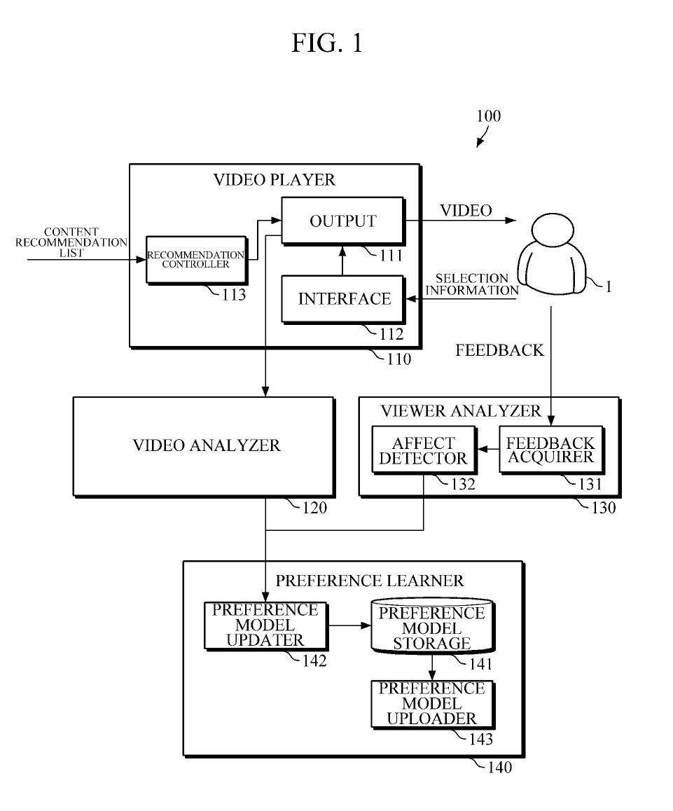

A system for recommending a TV program based on content according to an exemplary embodiment includes a terminal device configured to receive a broadcasting stream, and a recommendation server configured to recommend a TV program by receiving information about program preference for the terminal device. The terminal device performs the following operations: decoding and outputting the received broadcasting stream; detecting affectors by analyzing a video that is now being played; detecting affects that are an implicit response of a viewer of the video; learning a preference model using an affector matching each of the affectors; and transmitting the learned preference model to the server. Descriptions of the terminal device are provided in detail with reference to FIG. 1.

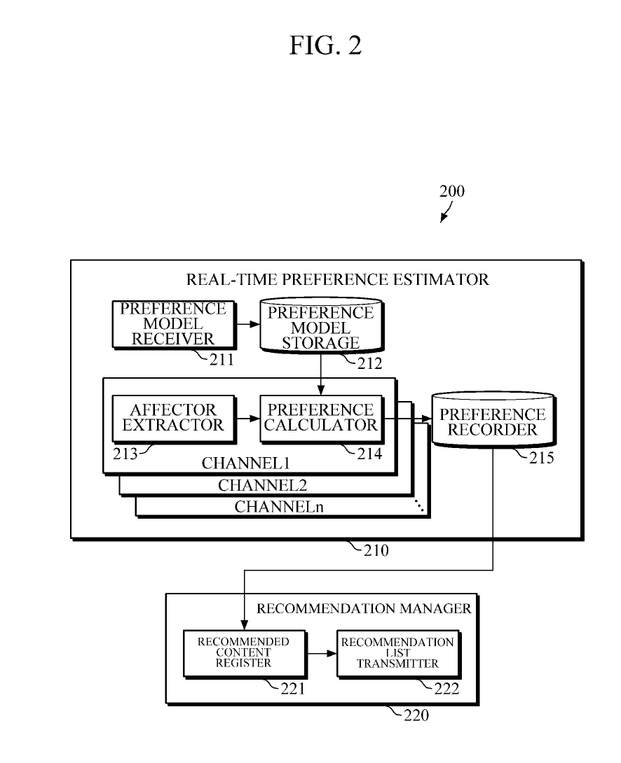

In response to receipt of the preference model from the terminal device, the recommendation server estimates real-time preference for each TV program that is now on air, by applying the preference model to two or more channels, respectively. In a case where real-time preference for a specific TV program is equal to or greater than a predetermined level, the recommendation server registers the specific TV program in a recommendation list and transmits the recommendation list to the terminal device. Descriptions of the recommendation server are provided in detail with reference to FIG. 2.

FIG. 1 is a diagram illustrating a terminal device according to an exemplary embodiment.

Referring to FIG. 1, a terminal device 100 includes a video player 110, a video analyzer 120, a viewer analyzer 130, and a preference learner 140.

The video player 110 plays and outputs a broadcasting stream, and includes an output 111, an interface 112, and a recommendation controller 113.

The output 111 receives and decodes a video stream, displays a video content item desired by a user on a screen, and outputs sound of the video content item through a speaker. The interface 112 receives a channel selecting signal from a user to control operations of the output 111. The interface 112 may include a remote control or may operate in association with a remote control.

Through the output 111, the recommendation controller 113 outputs a TV program recommendation list transmitted from the recommendation server 200. For example, a TV program recommendation list may be output as subscription scrolled below on the screen, or may be output in a form of a pop-up window in a specific area on the screen.

According to an exemplary embodiment, only when negative viewing feedback information is constantly received from the viewer analyzer 130 for a predetermined period of time, the recommendation controller 113 may output a TV program recommendation list on the screen. It is because if a TV program recommendation list is output in a form of a pop-up window on the screen, it may disturb a viewer when the viewer enjoys a TV program and does not need recommendation for any other TV program.

According to another exemplary embodiment, when a signal requesting for selection of a recommended program is received through the interface 113, the recommendation controller 113 may provide a time shift function in order to output a selected TV program. That is, in a case where the selected TV program is stored in a terminal storage or a server storage, it is possible to access a portion of the selected TV program, which is the missed portion immediately before the TV program is recommended. Then, the view start time is time-shifted (usually within an hour prior) to a predetermined time, so that the selected TV program may start from the beginning.

The video analyzer 120 detects affectors by analyzing content of a video output by the video player 110 in real time. An affector is a program's factor that may have an emotional impact on a viewer. The video analyzer 120 extracts two or more modal affectors from visual content, audio content, and text. For example, an affect may be set as color histogram information acquired from visual content, Mel Frequency Cepstrum Coefficients (MFCCs) acquired from audio content, and a combination of positive/negative emotional indicators for each word extracted from subscription texts.

The viewer analyzer 130 detects affects by analyzing response from a viewer who watched the video that is now being played. Specifically, the viewer analyzer 130 may include a feedback acquirer 131 and an affect detector 132.

The feedback acquirer 131 may acquire a viewer's implicit response to an affector using one or more of a three-dimensional (3D) camera, a depth sensor, and an Electro Dermal Activity (EDA) sensor. The viewer's implicit response indicates a non-linguistic response unconsciously made by people, including a facial expression, a body posture, and skin conductance.

The affect detector 132 detect affects, an emotional state of a viewer, by analyzing the viewer's implicit response acquired by the feedback acquirer 131. For example, the affects may include arousal as an emotional state of a viewer, and may selectively further include valance. In another example, the affects may include degrees of six emotions (anger, disgust, fear, happiness, sadness, and surprise) defined by Ekman.

The preference learner 140 receives an affector from the vide analyzer 120 and an affect from the viewer analyzer 130, and then generates and updates a preference model based on an affector-and-affect pair that exists for a predetermined period of time. The affector and affect may be values that are received in real time. Specifically, the preference learner 140 includes a preference model storage 141, a preference model updater 142, and a preference model uploader 143.

The preference model storage 141 stores a preference model that enables predicting a viewer's affect that is paired with a specific affector.

The preference model updater 142 calculates preference for an affector using an affect matching the affector, and learns a preference model using Machine Learning (ML). According to an exemplary embodiment, the preference model updater 143 may discover an affector-and-affect pair suitable for the preference model by regarding an arousal level of a viewer as a key element of preference and performing ML to search for a factor that have the biggest impact on the arousal level.

The preference model uploader 143 transmits a preference model, which that is updated by the affector and affect in real time, to the recommendation server 200. According to an embodiment, the preference model may be uploaded to the recommendation server 200 at predetermined time intervals.

FIG. 2 is a diagram illustrating a recommendation server according to an exemplary embodiment.

Referring to FIG. 2, a recommendation server 200 includes a real-time preference estimator 210 and a recommendation manager 220.

The real-time preference estimator 210 estimates real-time preference for each TV program using a preference model received from the terminal device 100, and calculates the accumulation of the estimated preference. Specifically, the real-time preference estimator 210 includes a preference model receiver 211, a preference model storage 212, an affector extractor 213, a preference calculator 214, and a preference recorder 215. The affector extractor 213 and the preference calculator 214 may be provided for each TV program that is being broadcast now in the air.

In response to receipt of a preference model from the terminal device 100, the preference model receiver 211 stores the received preference model in the preference model storage 212. The preference model indicates, not a viewer's response to a specific TV program, but abstract mathematical information that reflects the viewer's taste and orientation.

The affector extractor 213 extracts affectors from TV programs on a corresponding channel in real time.

Using a preference model stored in the preference model storage 212, the preference calculator 214 calculates a user's expected preference for each affector extracted by the affector extractor 131. Then, the preference calculator 214 accumulates the calculated preference for each TV program and updates the preference recorder 215 using the accumulated preference in real time. According to an exemplary embodiment, the preference calculator 214 may reset accumulated preference for each channel at predetermined time intervals by executing a timer when a specific TV program starts. It may prevent from recommending a program whose running time remaining is not enough when the recommendation is made.

According to another exemplary embodiment, the preference calculator 214 calculates in real time not just accumulated preference, but an increase per unit time in accumulated preference, and stores the both in the preference recorder 215.

The recommendation manager 220 monitors accumulated preference for each TV program, which is stored in the preference recorder 215, in real time. If accumulated preference for a specific video is equal to or greater than a predetermined level, the recommendation manager 220 registers the video in a recommendation list and transmits the recommendation list to the terminal device 100.

According to another exemplary embodiment, if an increase per unit time in accumulated preference for a specific video is equal to or greater than a predetermined level, the recommendation manager 220 may register the specific video in a recommendation list. It is because although there are TV programs with the same accumulated preference, a degree of preference may differ according to how long the preference has been accumulated.

Specifically, the recommendation manager 220 includes a recommended content item register 221 and a recommendation list transmitter 223. While monitoring the preference recorder 215 in real time, the recommendation register 221 extracts a TV program with accumulated preference being equal to or greater than a predetermined level and register the extracted TV program in a recommendation list. According to an exemplary embodiment, the recommendation list may be information on one or more TV programs that are ordered according to accumulated preference.

The recommendation list transmitter 222 transmits the recommendation list to the terminal device 100, if the number of recommended content items registered by the recommendation 221 is equal to or greater than a predetermined numeric value. According to an exemplary embodiment, the recommendation list may be transmitted in the way to push, or may be transmitted in response to a request from the terminal device.

Hereinafter, there are provided descriptions about a method for recommending a TV program based on content in the above-described system.

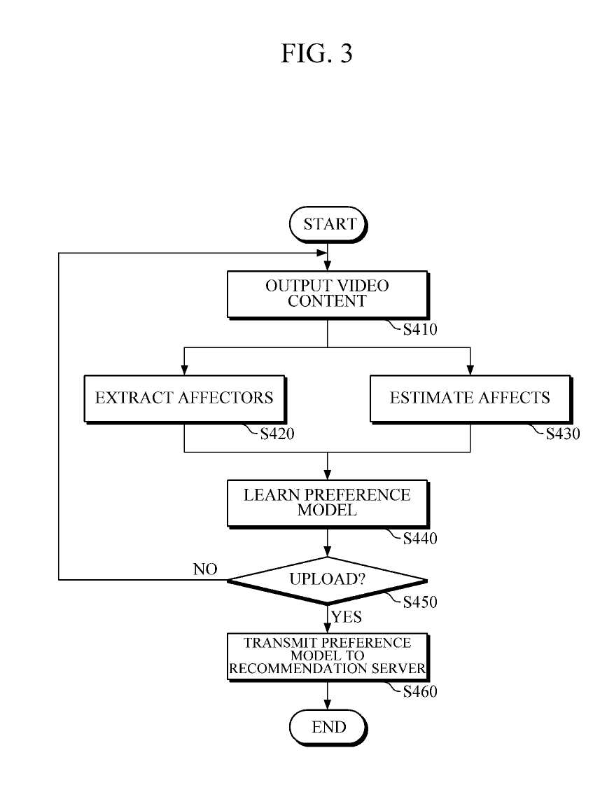

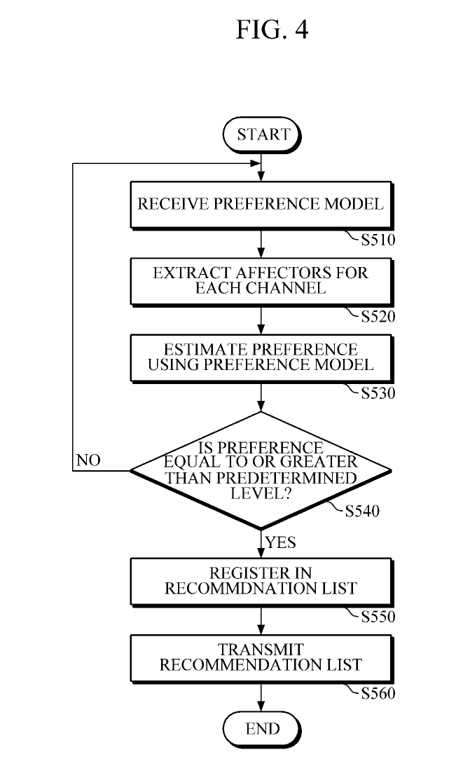

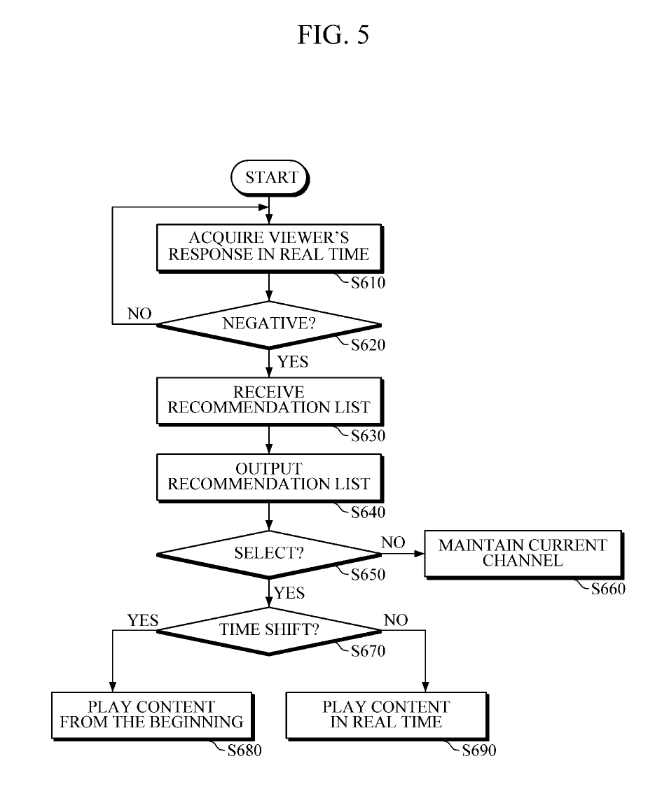

A method for recommending a TV program based on content according to an exemplary embodiment includes a process of generating a preference model according to a viewer's response (FIG. 3), a process of calculating preference for each channel using the preference model and generating a recommendation list according to the calculated preference (FIG. 4), and a process of outputting the recommendation list for the viewer (FIG. 5).

FIG. 3 is a flowchart for explanation of a process of generating a preference model according to a viewer's response according to an exemplary embodiment. FIG. 3 is described with reference to FIG. 1.

Referring to FIG. 3, the terminal device 100 receives and decodes video streams provided from a content provider 10, displays a video content item desired by a viewer, and outputs sound of the video content item through a speaker in 410.

The terminal device 100 extracts affectors by analyzing content of the output video in real time in 420. An affector may be a factor that defines a characteristic of a TV program and that may have an immediate impact on a viewer. According to an exemplary embodiment, at least two or more modal affectors may be extracted from among visual content, audio content, and text.

In addition, the terminal device 100 measures affects in 430 by acquiring implicit response of a viewer of the video and analyzing the implicit response.

The terminal device 100 learns a preference model using an extracted affector and a affect in 440. The preference model is not simply a viewer's response to a specific TV program, but information that reflects the viewer's taste and orientation. In addition, the terminal device 100 calculates preference for an affector using an affect matching the affector, and learns a preference model in real time using Machine Learning (ML).

The terminal device 100 may determine whether to upload the preference model to the recommendation server 200 in 450. In response to a determination made in 450 to upload the preference model to the recommendation server 200, the terminal device 100 transmits, to the recommendation server 200, the preference model that was learned using the affector and affect.

FIG. 4 is a flowchart for explanation of a process of generating a recommendation list using a preference model according to an exemplary embodiment. FIG. 4 is described with reference to FIG. 1.

Referring to FIG. 4, when receiving a preference model from the terminal device 100 in 510, the recommendation server 200 extracts affectors from a TV program on each channel in real time in 520.

The recommendation server 200 calculates a viewer's preference for each affector extracted using the preference model in 530. According to an exemplary embodiment, the recommendation server 200 accumulates the calculated preference for a TV program and updates the preference recorder 215 using the accumulated preference. According to an exemplary embodiment, the recommendation server 200 may reset accumulated preference for each channel at predetermined intervals by executing a timer at a time when each TV program starts.

By monitoring, in real time, each TV program's accumulated preference stored in the preference recorder 215, the recommendation server 200 determines whether there is any TV program with accumulated preference equal to or greater than a predetermined level in 540.

In response to a determination made in 540 that there is a TV program with accumulated preference equal to or greater than a predetermined level, the recommendation server 200 registers the TV program in a recommendation list in 550. According to an exemplary embodiment, the recommendation list may be information on one or more TV programs that are ordered according to accumulated preference thereof.

The recommendation server 200 transmits the TV program recommendation list to the terminal device 100 in 560. According to an exemplary embodiment, the recommendation list may be transmitted in a push type, or may be transmitted in response to the terminal device 100.

FIG. 5 is a flowchart illustrating a process of outputting a recommendation list to a viewer according to an exemplary embodiment.

Referring to FIG. 5, the terminal device 100 acquires a viewer's response in real time in 610, and determines whether a real-time response of the viewer is negative in 620. According to an exemplary embodiment, whether a negative response is received for a predetermined period of time is determined, and, if so, it is determined that the viewer's response is negative.

If it is determined in 620 that the real-time response of the viewer is negative, the terminal device 100 receives a TV program recommendation list from the recommendation server 200 in 630, and transmits the received TV program recommendation list on a screen in 640. For example, the TV program recommendation list may be output as subscription scrolled below on the screen, or may be output in a form of a pop-up window in a specific area on the screen.

Alternatively, if it is determined in 620 that the real-time response of the viewer is not negative, the terminal device 100 does not output a recommendation list, and instead proceeds with operation 610. It is because if a TV program recommendation list is output in a form of a pop-up window on the screen, it may disturb a viewer when the viewer enjoys a TV program and does not need recommendation for any other TV program.

The terminal device 100 determines whether a viewer inputs a signal for selecting any TV program from among the recommendation list in 650. According to a determination made in 650, the terminal device 100 may selectively maintain the current channel in 660 or change to a different channel. According to an exemplary embodiment, the terminal device 100 may provide a time shift function.

That is, the terminal device 100 determines in 670 whether there is a request for time shift. According to a determination made in 670, the terminal device 100 may play the corresponding TV program from the beginning by making the corresponding TV program time-shifted (usually within an hour prior) to a predetermined time, or may play content of the TV program in real time in 690.

The present disclosure may recommend any TV programs including a TV program, so that it may improve a viewer's satisfaction without degradation of usability in a multi-channel environment and lead to raise a real-time viewing rate, which will results in an increase in profits of a content provider. In addition, unlike the collaborative filtering technique, the present disclosure transmits an anonymous preference model, not personal view history, to a recommendation service provider, so that it may help to protect viewer's privacy.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal device comprising:
a video player configured to decode and output a received broadcast stream;
a video analyzer configured to extract affectors by analyzing a video that is being played by the video player;
a viewer analyzer configured to estimate affects that are an implicit response of a viewer of the video that is being played by the video player; and
a preference learner configured to learn a preference model using an affect matching each of the affectors, and transmit the learned preference model to a recommendation server.

2. The terminal device of claim 1, wherein the video player is further configured to receive a TV program recommendation list from the recommendation server and output the TV program recommendation list on a screen.

3. The terminal device of claim 2, wherein the video player is further configured to output the recommendation list on the screen in a case where a negative feedback information is received from the viewer analyzer for a predetermined period of time.

4. The terminal device of claim 2, wherein the video player provides a time shift function for the TV program selected from among the recommendation list.

5. The terminal device of claim 1, wherein the video analyzer is further configured to extract two or more modal affectors from among visual information, audio information, and text.

6. The terminal device of claim 1, wherein the viewer analyzer is further configured to estimate the affects by analyzing a viewer's response that is acquired using one or more of a video camera, a depth sensor, and an Electro Dermal Activity (EDA) sensor.

7. A recommendation server comprising:
a real-time preference estimator configured to, in response to receipt of a preference model from a terminal device, estimate real-time preference for each of a plurality of channels by applying the preference model to each of the plurality of channels in real time; and
a recommendation manager configured to register a specific TV program in a recommendation list and transmit the recommendation list to the terminal device in a case where a real-time preference for the specific TV program is equal to or greater than a predetermined level.

8. The recommendation server of claim 7, wherein the real-time preference estimator is further configured to accumulate estimated preference for each TV program.

9. The recommendation server of claim 8, wherein the recommendation list is information on one or more TV programs that are ordered according to accumulated preference thereof.

10. A method for recommending a TV program based on content, comprising:
decoding and outputting a received broadcast stream;
extracting affectors by analyzing an output video;
estimating affects that are a response of a viewer of the video;
learning a preference model using an affect matching each of the affectors; and
transmitting the learned preference model to a recommendation server.

11. The method of claim 10, further comprising:
outputting a recommendation list for TV programs, which is transmitted from the recommendation server.

12. The method of claim 11, wherein the outputting of a recommendation list comprises outputting the recommendation list on a screen when negative feedback information is received for a predetermined period of time.

13. The method of claim 11, further comprising:
providing a time shift function for a TV program selected from among the recommendation list.

14. The method of claim 10, wherein the extracting of affectors comprises extracting two or more modal affectors from among video content, audio content, and text.

15. A method for recommending a TV program based on content, comprising:
in response to receipt of a preference model from a terminal device, estimating real-time preference for each of a plurality of channels by applying the preference model to each of the plurality of channels in real time; and
in response to the real-time preference being equal to or greater than a predetermined level, registering a corresponding TV program in a recommendation list and transmitting the recommendation list to the terminal device.

16. The method of claim 15, wherein the estimating of real-time preference comprises accumulating estimated preference for each TV program.

17. The method of claim 15, wherein the recommendation list is information on one or more TV programs that are ordered according to accumulated preferences thereof.

18. A system for recommending a TV program based on content, comprising:
a terminal device configured to:
decode and output a received broadcast stream;
extract affectors by analyzing a video that is being played by the video player;
estimate affects that are an implicit response of a viewer of the video that is being played by the video player; and
learn a preference model using an affect matching each of the affectors and transmit the learned preference model to a recommendation server, and
the recommendation server configured to:
in response to receipt of a preference model from a terminal device, estimate real-time preference for each of a plurality of channels by applying the preference model to each of the plurality of channels in real time; and
register a specific TV program in a recommendation list and transmit the recommendation list to the terminal device in a case where a real-time preference for the specific TV program is equal to or greater than a predetermined level.
